(19) United States
(12) Patent Application Publication
(10) Pub. No.: US 2020/0087543 A1
(43) Pub. Date: Mar. 19, 2020

(54) Moisture-Curable Hot-Melt Adhesive Agent

(71) Applicant: Henkel AG & Co. KGaA, Duesseldorf (DE)

(72) Inventors: Kenji Matsuda, Osaka (JP); Ai Takamori, Osaka (JP); Tadashi Hayakawa, Osaka (JP)

(21) Appl. No.: 16/691,875

(22) Filed: Nov. 22, 2019

Related U.S. Application Data
(63) Continuation of application No. PCT/JP2018/019155, filed on May 17, 2018.

(30) Foreign Application Priority Data
May 30, 2017 (JP) 2017-106259

(51) Int. Cl. C09J 7/30; C09J 175/04; C09J 153/02; C09J 193/04; C08K 5/00; C08K 5/01

(52) U.S. Cl. CPC C09J 7/30; C09J 175/04; C09J 153/02; C08G 18/3855; C08K 5/0016; C08K 5/01; C09J 193/04

(57) ABSTRACT

There are provided a moisture curable hot melt adhesive excellent in balance among initial adhesion strength, post curing adhesion strength and heat resistance, and a layered product formed by bonding with that moisture curable hot melt adhesive agent. The moisture-curable hot melt adhesive comprises a urethane prepolymer having an isocyanate group at the end (A), a styrene based block copolymer (B), and an urethane modified rosin (C), wherein the urethane modified rosin (C) is a reaction product of a rosin derivative having hydroxyl group and an isocyanate compound.

### CROSS-REFERENCE TO RELATED APPLICATION

This application claims benefit under Article 4 of the Paris Convention based on Japanese Patent Application No. 2017-106259 filed in Japan on May 30, 2017, incorporated herein by reference in its entirety.

### TECHNICAL FIELD

The present invention relates to a moisture-curable hot-melt adhesive agent.

### BACKGROUND

A hot-melt adhesive agent is being used in various fields of building interior materials (or construction materials) and electronic materials. Particularly, the moisture-curable hot-melt adhesive agent is drawing attention because it is less likely to be affected by external factors and is easily used for a long period of time.

Examples of the moisture-curable hot-melt adhesive agent include an adhesive agent that comprises an urethane prepolymer having an isocyanate group at the end. The moisture-curable hot-melt adhesive agent is commonly applied in a hot molten state to at least one of a substrate and an adherend and cooled and solidified for initial adhesion. Then, the isocyanate group is cross-linked with moisture in atmospheric air to cause moisture curing and thus allow the urethane prepolymer to increase molecular weight thereof, so that the moisture-curable hot-melt adhesive agent is improved in adhesion force and heat resistance.

Initial adhesion strength is one of performance characteristics required of the moisture-curable hot-melt adhesive agent. In order to increase the initial adhesion strength, a tackifier resin is blended in the moisture-curable hot-melt adhesive agent to increase initial wettability to a substrate, or a thermoplastic resin is blended to improve initial aggregation force.

The tackifier resin and the thermoplastic resin, however, are not always sufficient in compatibility with the urethane prepolymer as a main component of the moisture-curable hot-melt adhesive agent.

Further, there have been problems of operation that a time (open time) that is until the moisture-curable hot-melt adhesive agent is cured after its application is excessively short to cause difficult operation, and viscosity of the adhesive agent is excessively increased to cause difficult application.

Patent Documents 1 to 3 disclose moisture-curable hot-melt adhesive agents comprising an urethane prepolymer and a thermoplastic resin. The moisture-curable hot-melt adhesive agent in any of the documents comprises an urethane prepolymer and a styrene based copolymer. Hereinafter, the disclosure of Patent Documents 1 to 3 is specifically described.

Patent Document 1 describes a reactive hot-melt adhesive agent composition comprising as main components an urethane prepolymer and a thermoplastic rubber composition (claim 1). Patent Document 1 provides, as the moisture-curable hot-melt adhesive agent, a reactive hot-melt adhesive agent composition that is improved in compatibility with a thermoplastic rubber by producing the urethane prepolymer with use of a prepolymer of a long-chain polyether having 6 or more carbon atoms and is thus excellent in compatibility, moisture-curability and adhesiveness.

Patent Document 1 discloses, as the thermoplastic rubber, a styrene-ethylene/butylene-styrene (SEBS) block copolymer (Example 1) and a styrene-butadiene-styrene (SBS) copolymer (Comparative Example 1). Patent Document 1 also discloses using as a tackifier an aliphatic based cyclic hydrocarbon (Example 1).

Patent Document 2 describes that, in a reactive hot-melt adhesive agent composition formed of an urethane prepolymer and a styrene based copolymer rubber, a polyester polyol is used as a polyether component for synthesis of the urethane prepolymer not to allow adhesion force to significantly decrease at 50 to 60° C. and thus to improve initial adhesion force.

Patent Document 2 discloses as the styrene based copolymer rubber, an SBS block copolymer (Example 1) and an SEBS block copolymer (Example 2). Patent Document 2 also discloses using as a tackifier resin an alicyclic saturated hydrocarbon (Example 1) and a terpene-styrene resin (Example 2).

Patent Document 3 describes that, in a reactive hot-melt adhesive composition comprising as main components an urethane prepolymer and a thermoplastic rubber component, a saturated hydrocarbon based polyol having a hydroxyl group at both terminals is used to give abundant compatibility with the thermoplastic rubber component and improve toughness and weather resistance such as non-yellowing.

Patent Document 3 discloses as the thermoplastic rubber component a styrene-isoprene-styrene (SIS) block copolymer in Table 1. The SIS is blended in an amount of 19 to 35 parts by weight of the urethane modified resin (C), based on 100 parts by weight of the urethane prepolymer and the SIS. Patent Document 3 also discloses using as a tackifier a hydrogenated dicyclopentadiene based petroleum resin (Example 1).

Patent Documents 1 and 2 give moisture-curable hot-melt adhesive agents bad in balance between initial adhesion strength and heat resistance, and Patent Document 3 gives a moisture-curable hot-melt adhesive agent remarkably low in initial adhesion strength.

When an addition amount of the tackifier resin is adjusted to improve initial adhesion strength of the moisture-curable hot-melt adhesive agent, the adhesive agent that has been taken care of (cured) decreases its adhesion strength. As described above, it is difficult to produce a moisture-curable hot-melt adhesive agent excellent in balance among various performance characteristics. Customers, however, are requiring a moisture-curable hot-melt adhesive agent excellent in balance among performance characteristics.

Accordingly, in recent years, a moisture-curable hot-melt adhesive agent is required to be rapidly developed that is excellent in balance among initial adhesion strength, adhesion strength of the adhesive agent that has been taken care of (cured), and heat resistance.

### BACKGROUND ART DOCUMENTS

Patent Document 1: Japanese Patent Laid-open Publication No. H02(1990)-212576

Patent Document 2: Japanese Patent Laid-open Publication No. H06(1994)-128552

Patent Document 3: Japanese Patent Laid-open Publication No. H02(1990)-272013

### SUMMARY OF INVENTION

### Problems to be Solved by the Invention

The present invention is achieved to solve the problems described above, and an object of the present invention is to provide a moisture-curable hot-melt adhesive agent excellent in balance among initial adhesion strength, post-curing adhesion strength and heat resistance, and a layered product obtained by bonding with the moisture-curable hot-melt adhesive agent.

### Means for Solving the Problems

The present invention provides a moisture-curable hot-melt adhesive agent comprising:

an urethane prepolymer having an isocyanate group at the end (A);

a styrene based block copolymer (B); and

an urethane modified rosin (C),

wherein

the urethane modified rosin (C) is a reaction product of a rosin derivative having hydroxyl group and an isocyanate compound.

In one embodiment, the rosin derivative having hydroxyl group is ester of rosin and polyhydric alcohol.

In one embodiment, the rosin derivative having hydroxyl group has a hydroxyl value of 2 to 180 mg KOH/g.

In one embodiment, the moisture-curable hot-melt adhesive agent is formed by comprising the urethane modified rosin (C) in an amount of 20 to 80 parts by weight of the urethane modified resin (C), based on 100 parts by weight in total of (A) and (B).

In one embodiment, any one of the moisture-curable hot-melt adhesive agents described above further comprises a hydrocarbon resin (D).

The present invention also provides a layered product comprising:

a substrate;

an adhesive layer formed on a surface of the substrate; and

an adherend adhered to a surface of the adhesive layer,

wherein

the adhesive layer consists of any one of the moisture-curable hot-melt adhesive agents described above.

The present invention also provides a method for producing a moisture-curable hot-melt adhesive agent, the method comprising a step of mixing an urethane modified rosin (C) obtained by a reaction of an isocyanate compound and a rosin derivative having hydroxyl group, a styrene based block copolymer (B), a polyol and an isocyanate compound.

In one embodiment, the method gives an urethane prepolymer (A) by mixing the polyol and the isocyanate compound.

### Effects of the Invention

The moisture-curable hot-melt adhesive agent according to the present invention is improved in initial adhesion strength, post-curing adhesion strength and heat resistance with good balance, is excellent particularly in initial adhesion strength at a temperature widely ranging from 5° C. to 35° C., and exhibits excellent initial adhesion strength at any of normal temperature (spring and summer), low temperature (winter) and high temperature (summer).

The moisture-curable hot-melt adhesive agent according to the present invention is excellent in balance among performance characteristics, is applied to various substrates regardless of a season or a warm or cold region, and may contribute to efficient production of many types of layered products.

### EMBODIMENTS FOR CARRYING OUT THE INVENTION

First described are technical terms used in the present specification.

The “open time” refers to a time from application of a molten moisture-curable hot-melt adhesive agent to an adherend until the adhesive agent does not show fluidity and is not capable of wetting a surface of the adherend.

The “initial adhesion strength” refers to adhesion strength of the moisture-curable hot-melt adhesive agent that has been melted and applied to an adherend and then solidified at low temperature. The initial adhesion strength is affected by wettability and aggregation force. The initial adhesion strength is preferred to be large.

The “wettability” may be measured when the moisture-curable hot-melt adhesive agent that has been heated and melted is brought into contact with a substrate (solid), specifically by size of an angle (α) of an end portion of the molten adhesive agent with respect to the substrate in contact with the molten adhesive agent. The smaller the α is, the larger the wettability is and the easier the adhesion is.

The “aggregation force” refers to force attributed to mutual action among molecules in a heated and melted moisture-curable hot-melt adhesive agent that is generated in a cooling process after application of the adhesive agent with an applicator.

Next described is the moisture-curable hot-melt adhesive agent according to the present invention.

### Urethane Prepolymer Having an Isocyanate Group at the End (A)

The moisture-curable hot-melt adhesive agent according to the present invention comprises an urethane prepolymer having an isocyanate group at the end (A) (hereinafter, also described as a “component (A)”). The urethane prepolymer having an isocyanate group at the end (A) is not particularly limited as long as it is normally understood as a “urethane prepolymer,” is a “urethane prepolymer having an isocyanate group at the end,” and is capable of giving an intended moisture-curable hot-melt adhesive agent.

Such an urethane prepolymer is obtained by reacting a polyol and an isocyanate compound according to a known method.

In the present specification, the “polyol” is not particularly limited as long as it is capable of giving an intended urethane prepolymer, and as the “polyol,” a publicly known polyol may be used that is utilized for normally producing polyurethane. The polyol preferably has 1 to 3 functional groups and is particularly preferred to be a bifunctional polyol, i.e., a diol. A polyol may be used alone, or polyols may be used in combination. Examples of the diol include low-molecular-weight diols such as ethylene glycol, 1-methylethylene glycol, 1-ethylethylene glycol, propylene glycol, butanediol, pentanediol, hexanediol, heptanediol, octanediol, nonanediol, decanediol, neopentyl glycol, 2-methyl-1,3-propanediol, cyclohexane dimethanol and 2,4-dimethyl-1,5-pentanediol. Preferred is at least one selected from ethylene glycol, butanediol, hexanediol, octanediol and decanediol. These diols may be used alone or in combination.

As the “polyol” in the present invention, a polyether polyol and a polyester polyol are also exemplified.

Examples of the polyether polyol include polyoxytetramethylene glycol (PTMG), polyoxypropylene glycol (PPG) and polyoxyethylene glycol (PEG). Particularly preferred as the polyether polyol is polyoxypropylene glycol.

Examples of the polyester polyol in the present invention include an aromatic polyester polyol and an aliphatic polyester polyol.

The aromatic polyester polyol is preferably obtained by a reaction of an aromatic carboxylic acid and a diol. Examples of the aromatic polycarboxylic acid include phthalic acid, isophthalic acid, terephthalic acid and hexahydroisophthalic acid. These may be used alone, or two or more of them may be used in combination. As one example of the aromatic polyester polyol, exemplified are a polyalkylene phthalate, a polyalkylene isophthalate and a polyalkylene terephthalate that each have an OH terminal. Particularly preferred as the aromatic polyester polyol is a polyalkylene phthalate having an OH terminal.

The aliphatic polyester polyols may be obtained by a reaction of an aliphatic carboxylic acid and a diol. Examples of the aliphatic carboxylic acid include adipic acid, sebacic acid, azelaic acid and decamethylene dicarboxylic acid. These may be used alone, or two or more of them may be used in combination. As one example of the aliphatic polyester polyol, exemplified are polyhexamethylene adipate (PHMA) and polybutylene adipate (PBA) that each have an OH terminal. Particularly preferred as the aliphatic polyester polyol is polyhexamethylene adipate having an OH terminal.

In the present invention, a particularly preferred aspect of the polyol is an aliphatic polyester polyol. As to the aliphatic polyester polyol, a single polyol may be used alone, or different two or more polyols may be used in combination.

Number average molecular weight of the polyol is not particularly limited but is preferably from 1,000 to 7,000. In the present specification, weight average molecular weight or number average molecular weight is obtained by use of gel permeation chromatography (GPC) and conversion of a result of the GPC into molecular weight using a calibration curve prepared for a standard substance, i.e., polystyrene having monodispersed molecular weight.

The isocyanate compound in the present invention is not particularly limited as long as it is capable of giving an intended urethane prepolymer, and any isocyanate compound is acceptable that is used for normally producing polyurethane. The isocyanate compound preferably has an average of 1 to 3 isocyanate groups per molecule and is particularly preferred to be a bifunctional isocyanate compound, i.e., a diisocyanate compound. An isocyanate compound may be used alone, or two or more isocyanate compounds may be used in combination.

Examples of the “isocyanate compound” include ethylene diisocyanate, ethylidene diisocyanate, propylene diisocyanate, butylene diisocyanate, hexamethylene diisocyanate, toluene diisocyanate, cyclopentylene-1,3-diisocyanate, cyclohexylene-1,4-diisocyanate, cyclohexylene-1,2-diisocyanate, 4,4′-diphenylmethane diisocyanate, 2,2′-diphenylpropane-4,4′-diisocyanate, p-phenylene diisocyanate, m-phenylene diisocyanate, xylylene diisocyanate, 1,4-naphthylene diisocyanate, 1,5-naphthylene diisocyanate, diphenyl-4,4′-diisocyanate, azobenzene-4,4′-diisocyanate, diphenyl sulfone-4,4′-diisocyanate, dichlorohexamethylene diisocyanate, furfurylidene diisocyanate and 1-chlorobenzene-2,4-diisocyanate. The isocyanate compounds may be used alone or in combination.

When the “urethane prepolymer” of the present invention is produced, a monool or a monoisocyanate compound may be used as long as it is capable of giving an intended urethane prepolymer. While a trifunctional polyol and a trifunctional isocyanate may be used, it is at least preferred to produce the urethane prepolymer with use of a bifunctional polyol (diol) and a bifunctional isocyanate compound (diisocyanate compound). It is more preferred to produce the “urethane prepolymer” by a reaction of a bifunctional polyol with a bifunctional isocyanate compound from the view point of heat stability of the moisture-curable hot-melt adhesive agent to be obtained and control of the production method (and production steps of the method).

In order to produce the urethane prepolymer having an isocyanate group at the end (A), the polyol is mixed with the isocyanate compound so as to give a molar ratio (NCO/OH) between an NCO group and an OH group of preferably 1.3 (lower limit) or more, more preferably 2 or more, and preferably 3 (upper limit) or less. It is preferred to use about 2 mol (approximately 1.8 mol to 2.3 mol) of a bifunctional isocyanate based on 1 mol of a bifunctional polyol because such a ratio allows production of an intended urethane prepolymer comparatively easily.

### Styrene Based Block Copolymer (B)

The moisture-curable hot-melt adhesive agent according to the present invention comprises a styrene-isoprene based block copolymer (B) (hereinafter, also described as a “component (B)”). The styrene based block copolymer (B) is a copolymer obtained by copolymerization of styrene as a vinyl based aromatic hydrocarbon and a conjugated diene compound and is a resin composition normally comprising something formed of a styrene block and a conjugated diene compound block.

The moisture-curable hot-melt adhesive agent according to the present invention comprises the styrene based block copolymer (B) to maintain a balance among heat resistance, initial adhesion strength and post-curing adhesion strength and to be excellent particularly in heat resistance.

The “conjugated diene compound” means a diolefin compound having at least a pair of conjugated double bonds. Specific examples of the “conjugated diene compound” include 1,3-butadiene, 2-methyl-1,3-butadiene (or isoprene), 2,3-dimethyl-1,3-butadiene, 1,3-pentadiene and 1,3-hexadiene. Particularly preferred are 1,3-butadiene and 2-methyl-1,3-butadiene. These conjugated diene compounds may be used alone or in combination.

The styrene based block copolymer (B) of the present invention may be an unhydrogenated product or a hydrogenated product.

The “unhydrogenated product of the styrene based block copolymer (B)” specifically refers to a styrene based block copolymer whose conjugated diene compound block is not hydrogenated.

The “hydrogenated product of the styrene based block copolymer (B)” specifically refers to a block copolymer whose conjugated diene compound blocks are entirely or partially hydrogenated.

Proportion of hydrogenation in the “hydrogenated product of the styrene based block copolymer (B)” may be represented by “percentage of hydrogenation.” The “percentage of hydrogenation” of the “hydrogenated product of the styrene based block copolymer (B)” refers to proportion of a double bond that has been hydrogenated and converted into a saturated hydrocarbon bond in all aliphatic double bonds as a reference that are contained in the conjugated diene compound block. The “percentage of hydrogenation” may be measured by an infrared spectrophotometer and a nuclear magnetic resonance apparatus.

Specific examples of the “unhydrogenated product of the styrene based block copolymer (B)” include a styrene-isoprene-styrene block copolymer (“SIS”) and a styrene-butadiene-styrene (block copolymer “SBS”).

Specific examples of the “hydrogenated product of the styrene based block copolymer (B)” include a styrene-ethylene/propylene-styrene block copolymer (“SEPS”) and styrene-ethylene/butylene-styrene (“SEBS”).

The styrene based block copolymer (B) may be any of a radial type, a linear type and a triblock type as long as it does not impair the object of the present invention.

In the present invention, the styrene based block copolymer (B) preferably comprises a styrene based block copolymer having a styrene content rate of 15% by weight or more, particularly preferably comprises both a styrene based block copolymer having a styrene content rate of 15 to 35% by weight (B1) and a styrene based block copolymer having a styrene content rate of 40 to 70% by weight (B2).

The hot-melt adhesive agent according to the present invention comprises the styrene based block copolymer having a styrene content rate of 15% by weight or more to be more excellent in balance among initial adhesion strength, post-curing adhesion strength and heat resistance and comprises both the (B1) and the (B2) to be excellent at a higher level in balance among initial adhesion strength, post-curing adhesion strength and heat resistance.

In the present invention, the (B1) comprises a styrene-isoprene based block copolymer, and the (B2) more preferably comprises a styrene-isoprene based block copolymer.

In the present specification, the “styrene content rate” refers to proportion of the styrene block contained in the styrene based block copolymer (B).

In the present invention, the styrene based block copolymer having a styrene content rate of 15 to 35% by weight (B1) has a diblock content rate of preferably 30 to 70% by weight, most desirably 35 to 60% by weight.

In the present specification, the styrene based block copolymer having a styrene content rate of 40 to 70% by weight (B2) has a diblock content rate of preferably less than 40% by weight, particularly desirably 30% by weight or less, most desirably 0% by weight. The styrene based block copolymer (B2) having a diblock content rate of 0% by weight is a triblock copolymer.

In the present specification, the “diblock content rate” refers to proportion of a styrene-conjugated diene compound block copolymer contained in the (B). The diblock is represented by the following formula (1).

[Chemical Formula 1]

S-E (1)

(S represents a styrene block, and E represents a conjugated diene compound block.)

As the styrene based block copolymer (B) of the present invention, a commercially available product may be used.

Examples of the (B1) include Asaprene T432 (manufactured by Asahi Kasei Corp.) as a styrene-butadiene-styrene block copolymer; and Quintac SL-165 (manufactured by Zeon Corporation), VECTOR 4411A (manufactured by Dexco), VECTOR 4211A (manufactured by Dexco), Quintac 3270 (manufactured by Zeon Corporation), Quintac 3460 (manufactured by Zeon Corporation), Quintac 3433N (manufactured by Zeon Corporation) and Quintac 3450 (manufactured by Zeon Corporation) as a styrene-isoprene-styrene block copolymer.

Examples of the (B2) include Asaprene T439 (manufactured by Asahi Kasei Corp.) as a styrene-butadiene-styrene block copolymer; and KRATON D1162 (manufactured by Kraton Corporation), Quintac 3390 (manufactured by Zeon Corporation) and Quintac SL-168 (manufactured by Zeon Corporation) as a styrene-isoprene-styrene block copolymer.

The components of these commercially available products may each be used alone or may be used in combination of two or more components.

### Urethane Modified Rosin (C)

The moisture-curable hot-melt adhesive agent according to the present invention comprises an urethane modified rosin (C) (hereinafter, also described as a “component (C)”). The urethane modified rosin (C) refers to a modified rosin obtained by reacting an “isocyanate compound” and a “rosin derivative having hydroxyl group.” The “rosin derivative having hydroxyl group” refers to a derivative obtained by modifying a rosin so as to have a hydroxyl group. For example, a reaction of a rosin and a diol bonds a carboxyl group of the rosin with one hydroxyl group of the diol by an ester bond to give a rosin derivative having hydroxyl group.

The urethane modified rosin (C) is obtained by reacting a hydroxyl group contained in the rosin derivative and the isocyanate compound. The hydroxyl group of the rosin derivative reacts with an isocyanate group to form an urethane bond. Accordingly, the urethane modified rosin (C) does not substantially have a hydroxyl group not to substantially react and an isocyanate compound. It is preferred that the urethane modified rosin (C) do not substantially have an isocyanate group.

Accordingly, at the time of producing the moisture-curable hot-melt adhesive agent, even when the urethane modified rosin (C) is added to a mixture of the polyol and the isocyanate compound that form the prepolymer, the urethane modified rosin (C) does not substantially affect a reaction of the polyol and the isocyanate compound to eliminate the need for excessively adding an isocyanate compound. This makes the moisture-curable hot-melt adhesive agent comprising the “urethane modified rosin (C)” of the present invention described above excellent in balance among initial adhesion strength, post-curing adhesion strength and heat resistance, particularly excellent in post-curing adhesion strength.

In the present invention the “urethane modified rosin (C)” refers to a modified rosin that is obtained by a reaction of a rosin derivative having hydroxyl group and an isocyanate compound and contains in its molecule an urethane bond formed by a reaction of a hydroxyl group and an isocyanate group. For production of the urethane modified rosin (C), a diol may further be used that has a weight average molecular weight of 1000 or less.

The “rosin derivative having hydroxyl group” is as described above. The rosin derivative, however, is more specifically ester of rosin and polyhydric alcohol, a formalin-modified rosin or a modified rosin alcohol, for example, and refers to a rosin derivative having a remaining hydroxyl group. The rosin derivative having hydroxyl group has a hydroxyl value of commonly 2 to 180 mg KOH/g, preferably 4 to 80 mg KOH/g, more preferably 6 to 40 mg KOH/g.

The rosin derivative having a hydroxyl value in the ranges described above makes the moisture-curable hot-melt adhesive agent according to the present invention more excellent in balance among initial adhesion strength, post-curing adhesion strength and heat resistance.

The “rosin derivative having hydroxyl group” of the present invention has a remaining hydroxyl group as a result of various types of modification performed on a rosin, and ester of rosin and polyhydric alcohol is exemplified as a most common rosin derivative having hydroxyl group.

Examples of the “rosin” include unmodified rosins such as a gum rosin, a wood rosin and a tall oil rosin as well as disproportionated rosins, hydrogenated rosins and polymerized rosins based on these rosins, and purified products of these rosins. It is also possible to use reinforced rosins obtained by adding to these rosins maleic acid, maleic anhydride, fumaric acid and acrylic acid as well as modified products of these rosins.

Examples of the polyhydric alcohol include dihydric alcohols such as ethylene glycol, propylene glycol, diethylene glycol and dipropylene glycol, trihydric alcohols such as glycerin and trimethylolpropane, tetrahydric alcohols such as pentaerythritol and diglycerin, and hexahydric alcohols such as dipentaerythritol.

The ester of a rosin and a polyhydric alcohol (hereinafter, also referred to as a “rosin ester”) may be obtained by a known method. For example, the ester may be obtained by heating a rosin and an alcohol in an inert atmosphere such as nitrogen gas. This process is performed under the reaction conditions of commonly 250 to 280° C. and 5 to 20 hours.

The production method may also be applied for a formalin-modified rosin and a modified rosin alcohol, and further for a rosin on which is performed modification such as phenolation.

The “isocyanate compound” as a raw material for the urethane modified rosin may be identical or different from the “isocyanate compound” described for the production of the “urethane prepolymer.” The “isocyanate compound” as a material for the urethane modified rosin is acceptable as long as the compound has at least one isocyanate group, and may be a monoisocyanate or a diisocyanate. The isocyanate compound may also be an isocyanate to which a polyhydric alcohol is added.

In the moisture-curable hot-melt adhesive agent according to the present invention, the contents of the components (A), (B) and (C) may be defined on the basis of a total 100 parts by weight of the urethane prepolymer having an isocyanate group at the end (A) and the styrene-isoprene based block copolymer (B). That is, the contents are as follows:

component (A): commonly 25 to 85 parts by weight, preferably 30 to 70 parts by weight, more preferably 40 to 60 parts by weight; and

component (C): commonly 25 to 90 parts by weight, preferably 30 to 80 parts by weight, more preferably 38 to 78 parts by weight.

The urethane modified rosin (C) having a content in the ranges described above allows the moisture-curable hot-melt adhesive agent according to the present invention to maintain a balance among heat resistance, initial adhesion strength and post-curing adhesion strength and makes the adhesive agent particularly excellent in post-curing adhesion strength.

### Hydrocarbon Resin (D)

In the present invention, the hydrocarbon resin (D) is not particularly limited as long as it consists of only carbon and hydrogen and is capable of giving the moisture-curable hot-melt adhesive agent intended in the present invention.

Examples of the hydrocarbon resin (D) include a natural rosin, a hydrogenated rosin, a copolymer of a natural terpene, a terpolymer of a natural terpene, a hydrogenated derivative of a copolymer of a hydrogenated terpene, a polyterpene resin, a hydrogenated derivative of a phenol based modified terpene resin, an aliphatic petroleum hydrocarbon resin, a hydrogenated derivative of an aliphatic petroleum hydrocarbon resin, an aromatic petroleum hydrocarbon resin, a hydrogenated derivative of an aromatic petroleum hydrocarbon resin, a cyclic aliphatic petroleum hydrocarbon resin and a hydrogenated derivative of a cyclic aliphatic petroleum hydrocarbon resin. These hydrocarbon resins may be used alone or in combination.

As the hydrocarbon resin (D), a commercially available product may be used. Examples of such a commercially available product include MARUKA CLEAR H (trade name) manufactured by Maruzen Petrochemical Co., Ltd., CLEARON K100 (trade name), CLEARON K4090 (trade name) and CLEARON K4100 (trade name) manufactured by YASUHARA CHEMICAL CO., LTD., ARKON M100 (trade name) manufactured by ARAKAWA CHEMICAL INDUSTRIES, LTD., I-MARV 5100 (trade name) manufactured by Idemitsu Kosan Co., Ltd., T-REZ HA103 (trade name), T-REZ HA125 (trade name) and T-REZ HC103 (trade name) manufactured by TonenGeneral Sekiyu K.K., and Regalite R7100 (trade name) manufactured by Eastman Chemical Company. These commercially available hydrocarbon resins may be used alone or in combination.

### Plasticizer (E)

The moisture-curable hot-melt adhesive agent according to the present invention preferably comprises a plasticizer (E) in addition to the components (A) to (C). The plasticizer (E) allows the moisture-curable hot-melt adhesive agent to maintain somewhat low viscosity while the plasticizer (E) improves compatibility of the components (A) to (C). The moisture-curable hot-melt adhesive agent is low in viscosity and thus is excellent in coatability to increase wettability to an adherend, so that the initial adhesion strength is improved.

In the present invention, the plasticizer (E) is not particularly limited as long as it is normally used and is capable of giving the moisture-curable hot-melt adhesive agent intended in the present invention.

Examples of the plasticizer (E) include a paraffin based oil, a naphthene based oil, an aromatic based oil, dioctyl phthalate, dibutyl phthalate, dioctyl adipate and mineral spirit.

As the plasticizer (E), a commercially available product may be used. Examples of the commercially available product include White Oil Broom 350 (trade name) manufactured by Kukdong Oil & Chemicals Co., Ltd., Diana Fresia S32 (trade name), Diana Process Oil PW-90 (trade name) and DN Oil KP-68 (trade name) manufactured by Idemitsu Kosan Co., Ltd., Enerper M1930 (trade name) manufactured by BP Chemicals Ltd., Kaydol (trade name) manufactured by Crompton Corporation, Primol 352 (trade name) manufactured by Esso, Process Oil NS100 manufactured by Idemitsu Kosan Co., Ltd., and KN4010 (trade name) manufactured by PetroChina Company Limited. These plasticizers (E) may be used alone or in combination.

The moisture-curable hot-melt adhesive agent according to the present invention may comprise another additive as necessary. The “additive” is not particularly limited as long as it is normally used for a moisture-curable hot-melt adhesive agent and may be used for the moisture-curable hot-melt adhesive agent according to the present invention. Examples of such an additive include a plasticizer, an antioxidant, a pigment, a photostabilizer, a flame retardant, a catalyst and a wax.

Examples of the “antioxidant” include a phenol based antioxidant, a phosphite based antioxidant, a thioether based antioxidant and an amine based antioxidant.

Examples of the “pigment” include titanium oxide and carbon black.

Examples of the “photostabilizer” include benzotriazole, hindered amine, benzoate and benzotriazole.

Examples of the “flame retardant” include a halogen based flame retardant, a phosphorous based flame retardant, an antimony based flame retardant and a metal hydroxide based flame retardant.

Examples of the “catalyst” include metal based catalysts such as tin based catalysts (trimethyltin laurate, trimethyltin hydroxide, dibutyltin dilaurate and dibutyltin maleate), lead based catalysts (lead oleate, lead naphthenate and lead octenoate) and other metal based catalysts (naphthenic acid metal salts such as cobalt naphthenate), and amine based catalysts such as triethylenediamine, tetramethylethylenediamine, tetramethylhexylenediamine, diazabicycloalkenes and dialkylaminoalkylamines.

Examples of the “wax” include waxes such as a paraffin wax and a microcrystalline wax.

A method for producing the moisture-curable hot-melt adhesive agent according to the present invention is acceptable as long as it includes a step of mixing the components (A) to (C), the components (D) and (E) as necessary, and various additives, and is not particularly limited in terms of an order and a method of mixing the components. One or both of the polyol and the isocyanate compound for obtaining the urethane prepolymer (A) may be simultaneously mixed with the styrene based block copolymer (B) and the urethane modified rosin (C), or the polyol may be reacted with the isocyanate compound in advance to produce the urethane prepolymer (A), followed by mixing the urethane prepolymer (A) with the other components (B) and (C).

The urethane modified rosin (C) is preferably synthesized before it is mixed with the urethane prepolymer (A). Such preparation does not allow the “rosin derivative having hydroxyl group” or the “isocyanate” as a raw material for the urethane modified rosin (C) to react with the “polyol” or the “isocyanate compound” as a raw material for the urethane prepolymer (A). This allows the moisture-curable hot-melt adhesive agent according to the present invention to certainly comprise the urethane modified rosin (C), so that the moisture-curable hot-melt adhesive agent may maintain a good balance among heat resistance, initial adhesion strength and post-curing adhesion strength.

The moisture-curable hot-melt adhesive agent according to the present invention may be produced by heating, melting and mixing the components mutually. For example, the moisture-curable hot-melt adhesive agent may be produced by charging the components into a stirrer-equipped melting mixing pot and heating and mixing the components.

The moisture-curable hot-melt adhesive agent obtained as described above is a reactive hot-melt adhesive agent, is a solid at room temperature, and may be used according to a usual method for a reactive hot-melt adhesive agent. Commonly, the moisture-curable hot-melt adhesive agent is heated and melted for use.

### Layered Product

A layered product according to the present invention includes the moisture-curable hot-melt adhesive agent described above. The layered product is produced by laminating a surface of a “substrate” and an “adherend” with use of the moisture-curable hot-melt adhesive agent according to the present invention. When the layered product is produced, the moisture-curable hot-melt adhesive agent may be applied to the substrate, the adherend or both the substrate and the adherend. Materials and forms of the substrate and the adherend may be identical or different.

The “substrate” is not particularly limited, and the following are exemplified, for example:

woody materials such as plywood (e.g., lauan plywood), a medium density fiberboard (MDF), a particle board, solid wood and a woody fiber board;

inorganic materials such as a cement board, a gypsum board and autoclaved lightweight concrete (ALC); and

plastic materials such as polyethylene terephthalate, polycarbonate, polyurethane, polyethylene and polypropylene.

The form of the “substrate” is not also particularly limited and is acceptable as any of a molded resin form, a film form and a sheet form.

As the “adherend,” any normally used material is acceptable, and the adherend is not particularly limited. Specific examples of the adherend include a film and a sheet.

The film may be colorless or colored and transparent or opaque. Examples of the film include films made from a polyolefin resin, a polyester resin, an acetate resin, a polystyrene resin and a vinyl chloride resin. Examples of the polyolefin resin include polyethylene and polypropylene. Examples of the polyester resin include polyethylene terephthalate.

The adherend may be a decorative sheet. As the decorative sheet, the following are exemplified, for example:

sheets made from plastic materials such as a vinyl chloride resin, a polyolefin resin and a polyester resin that are rigid or semirigid;

sliced veneer prepared by processing wood into a sheet form; and

decorative paper provided with various decorative prints.

The layered product according to the present invention is applicable to various uses, specifically for a building material, furniture, an electronic material and an automobile field, for example.

The layered product may be produced with use of commonly known production apparatuses including a carrier machine, a coater, a pressing machine, a heater and a cutting machine, without using a special apparatus.

For example, the layered product may be produced as follows. The moisture-curable hot-melt adhesive agent according to the present invention is applied to the substrate or the adherend with a coater while the substrate and the adherend are carried by a carrier machine. A heater is controlled at a predetermined temperature when the application is performed. The adherend is lightly pressed against the substrate with a pressing machine to be adhered to the substrate with the moisture-curable hot-melt adhesive agent interposed between the adherend and the substrate. Then, the adhered adherend and substrate is allowed to cool and directly carried by a carrier machine to solidify the moisture-curable hot-melt adhesive agent. Then, the substrate having the adherend adhered thereto is cut with a cutting machine into an appropriate size.

The moisture-curable hot-melt adhesive agent according to the present invention is high in initial adhesion strength, sufficient in post-curing adhesion strength, and excellent in heat resistance, so that the layered product according to the present invention is a product that is efficiently produced and is excellent in various qualities.

### EXAMPLES

Hereinafter, the present invention is described by way of examples and comparative examples. These examples, however, are for describing the present invention and do not limit any of the present invention.

Components for producing the hot-melt adhesive agent are as follows.

Materials for constituting urethane prepolymer having an isocyanate group at the end (A) (polyol component and isocyanate component)

### Polyol Component

Polyester polyol (Al) (HS 2F-231AS (trade name) manufactured by Hokoku Corporation, melting point 30° C., hydroxyl value 56 (mg KOH/g))
Polyester polyol (A2) (HS 2H-350S (trade name) manufactured by Hokoku Corporation, melting point −5° C., hydroxyl value 32 (mg KOH/g))
Polyester polyol (A3) (HS 2E-581A (trade name) manufactured by Hokoku Corporation, melting point −5° C., hydroxyl value 21 (mg KOH/g))
Polypropylene glycol (A4) (HIFLEX D-2000 (trade name) manufactured by DKS Co. Ltd., hydroxyl value 56 (mg KOH/g))

### Isocyanate Component

4,4′-diphenylmethane diisocyanate (A5) (Millionate MT (trade name) manufactured by Tosoh Corporation)

### Styrene Based Block Copolymer (B)

Styrene-ethylene-butylene block copolymer (B1-1) (G1657 (trade name) manufactured by Kraton Corporation, styrene content rate 13% by weight, diblock content rate 30% by weight, MFR 8 g/10 min: 200° C.)
Styrene-isoprene block copolymer (B1-2) (JSR5403 (trade name) manufactured by JSR Corporation, styrene content rate 15% by weight, diblock content rate 40% by weight, MFR 20 g/10 min: 200° C.)
Styrene-isoprene block copolymer (B1-3) (Quintac 3433N (trade name) manufactured by Zeon Corporation, styrene content rate 16% by weight, diblock content rate 56% by weight, MFR 12 g/10 min: 200° C.)
Styrene-isoprene block copolymer (B1-4) (Quintac 3270 (trade name) manufactured by Zeon Corporation, styrene content rate 24% by weight, diblock content rate 67% by weight, MFR 20 g/10 min: 200° C.)
Styrene-isoprene block copolymer (B1-5) (Quintac SL-165 (trade name) manufactured by Zeon Corporation, styrene content rate 30% by weight, diblock content rate 60% by weight, MFR 16 g/10 min: 200° C.)
Styrene-butadiene block copolymer (B1-6) (Asaprene T432 (trade name) manufactured by Asahi Kasei Chemicals Corporation, styrene content rate 30% by weight, diblock content rate 25% by weight, MFR 0.2 g/10 min: 200° C.)
Styrene-isoprene block copolymer (B2-1) (D-1162 (trade name) manufactured by Kraton Corporation, styrene content rate 43% by weight, diblock content rate 0% by weight (triblock co-aggregate), MFR 45 g/10 min: 200° C.)
Styrene-butadiene block copolymer (B2-2) (Asaprene T439 (trade name) manufactured by Asahi Kasei Chemicals Corporation, styrene content rate 45% by weight, diblock content rate 62% by weight, MFR undisclosed)
Styrene-butadiene block copolymer (B2-3) (TR2250 (trade name) manufactured by JSR Corporation, styrene content rate 52% by weight, diblock content rate 0% by weight (triblock co-aggregate), MFR 4.0 g/10 min: 200° C.)
Styrene-butadiene/butylene block copolymer (B2-4) (Tuftec P2000 (trade name) manufactured by Asahi Kasei Chemicals Corporation, styrene content rate 67% by weight, diblock content rate 0% by weight (triblock co-aggregate), MFR 3.0 g/10 min: 190° C.)
Ethylene ethyl acrylate copolymer (B′3) (NUC6070 (trade name) manufactured by NUC Corporation, ethyl acrylate content rate 25% by weight, MFR 250 g/10 min: 190° C.)

### Urethane Modified Rosin (C)

Urethane modified rosin (C1) (The production method is described later (Table 1).)
Urethane modified rosin (C2) (The production method is described later (Table 1).)
Urethane modified rosin (C3) (The production method is described later (Table 1).)
Urethane modified rosin (C4) (The production method is described later (Table 1).)
   Hydrocarbon resin (D)
Unhydrogenated C5 resin (D1) (Wingtack 86 (trade name) manufactured by Cray Valley, softening point 87° C.)
Completely hydrogenated DCPD resin (D2) (T-REZ HA103 (trade name) manufactured by TonenGeneral Sekiyu K.K., softening point 103° C.)
Partially hydrogenated C9 resin (D3) (ARKON M100 (trade name) manufactured by ARAKAWA CHEMICAL INDUSTRIES, LTD., softening point 100° C.)
Completely hydrogenated C9 resin (D4) (ARKON P125 (trade name) manufactured by ARAKAWA CHEMICAL INDUSTRIES, LTD., softening point 125° C.)

### Plasticizer (E)

Naphthene oil (E1) (SUNPURE N90 (trade name) manufactured by JAPAN SUN OIL COMPANY, LTD.)
Paraffin oil (E2) (Daphne Oil KP68 (trade name) manufactured by Idemitsu Kosan Co., Ltd.)
Rice oil (E3) (rice salad oil (trade name) manufactured by Boso oil and fat Co., Ltd.)

### Other Additive (F)

Antioxidant (F1) (ADK STAB AO-60 (trade name) manufactured by ADEKA Corporation)

### Method for Producing Moisture-Curable Hot-Melt Adhesive Agent

A method for producing an urethane modified rosin is described below.

First, a rosin ester component (G) was charged into a reaction vessel and melted in an oven at 130° C., and then moisture was removed by stirring the component for 1 hour under reduced pressure while the reaction vessel was heated in oil bath at 130° C. Next, the isocyanate component (A5) or (H1) was charged at an NCO/OH ratio of 1.05 and stirred for 1 hour under reduced pressure at 130° C. to give an urethane modified rosin (C).

The urethane modified rosin was subjected to infrared spectroscopic spectrum analysis (FT-IR analysis), and it was confirmed that absorption of 2300 cm⁻¹ by an isocyanate group and absorption of 3400 cm⁻¹ by a hydroxyl group were almost lost.

Combinations of rosin ester components with isocyanate components are as shown in Table 1.

TABLE 1

| Urethane | Combination |
|---|---|
| modified rosin | of components |
| (C1) | (G1) |
| | (A5) |
| (C2) | (G1) |
| | (H1) |
| (C3) | (G2) |
| | (H1) |
| (C4) | (G3) |
| | (H1) |

### Rosin Ester as Component for Constituting Urethane Modified Rosin (G)

Hydroxyl group-containing rosin ester resin (G1) (SYLVALITE RE85GB (trade name) manufactured by Arizona Chemical Holdings Corporation, softening point 85° C., hydroxyl value 25 (mg KOH/g))
Hydroxyl group-containing rosin ester resin (G2) (SYLVALITE RE105L (trade name) manufactured by Arizona Chemical Holdings Corporation, softening point 105° C., hydroxyl value 10 (mg KOH/g))
Hydroxyl group-containing rosin ester resin (G3) (SUPER ESTER T125 (trade name) manufactured by ARAKAWA CHEMICAL INDUSTRIES, LTD., softening point 125° C., hydroxyl value 7 (mg KOH/g))
   Isocyanate as component for constituting urethane modified rosin (H)
p-Toluene sulfonyl isocyanate (H1) (manufactured by Wako Pure Chemical Industries, Ltd.)

### Example 1

The components (A) to (E) were mixed to produce a moisture-curable hot-melt adhesive agent.

Specifically, the components (B1-5), (B2-1), (C1), (D3), (D4), (E1) and (F1) at the composition (parts by weight) indicated in Table 2 were melted and mixed with a versatile stirrer over about 1 hour at about 145° C. to prepare a molten composition.

Next, the polyester polyol (A3) was mixed with the molten composition at the composition (parts by weight) indicated in Table 2, and this mixture was put into a reaction vessel. The mixture was heated at 130° C. for 1 hour and stirred for 1 hour under reduced pressure at the same temperature. After it was confirmed that moisture was removed and the mixture was sufficiently kneaded, the 4,4′-diphenylmethane diisocyanate (A5) was added and stirred for 1 hour under reduced pressure at the same temperature to give a moisture-curable hot-melt adhesive agent.

### Examples 2 to 9 and Comparative Examples 1 to 4

The components (A) to (E) were prepared by the same steps as in Example 1 at the composition indicated in Tables 2, 4 and 6 to product a moisture-curable hot-melt adhesive agent.

The hot-melt adhesive agents of the examples and the comparative examples that were obtained as described above were measured for melt viscosity, heat resistance (creep test), initial adhesion strength (tack) and post-curing adhesion strength (durability test). Tables 3, 5 and 7 show the results of the measurements.

TABLE 2

| Classification | Classification | | | | | | |
|---|---|---|---|---|---|---|---|
| of raw | of raw | Classification of | | | | | |
| materials 1 | materials 2 | raw materials 3 | Example 1 | Example 2 | Example 3 | Example 4 | Example 5 |
| Urethane | Polyol | (A1) | | | | | |
| prepolymer | | (A2) | | | | | 24.6 |
| (A) | | (A3) | 57.5 | 53.3 | 19.2 | 56.9 | 45.4 |
| | | (A4) | | | 7.7 | | |
| | Isocyanate | (A5) | 5.7 | 6.1 | 3.8 | 5.6 | 7.0 |
| Styrene based | Low styrene | (B1-1) | | | | | |
| block | content rate | (B1-2) | | 16.8 | | | |
| copolymer | (B1) | (B1-3) | | | | | |
| (B) | | (B1-4) | | | 34.6 | 37.5 | 23.0 |
| | | (B1-5) | 14.7 | | | | |
| | | (B1-6) | | | | | |
| | High styrene | (B2-1) | 22.1 | 23.8 | 34.6 | | |
| | content rate | (B2-2) | | | | | |
| | (B2) | (B2-3) | | | | | |
| | | (B2-4) | | | | | |

| | | | | | | |
|---|---|---|---|---|---|---|
| Ethylene ethyl acrylate | (B′ 3) | | | | | |
| copolymer | | | | | | |
| Urethane modified rosin (C) | (C1) | 56.1 | 39.4 | | | |
| | (C2) | | | 73.7 | | |
| | (C3) | | | | 38.9 | 25.5 |
| | (C4) | | | | | |
| Hydrocarbon resin (D) | (D1) | | | | 41.7 | 24.6 |
| | (D2) | | 14.5 | | | |
| | (D3) | 10.5 | | | | |
| | (D4) | 23.2 | 25.7 | | | |
| Plasticizer (E) | (E1) | 24.2 | | | 29.2 | 14.8 |
| | (E2) | | 14.9 | | | |
| | (E3) | | | 28.8 | | |
| Additive (F) | (F1) | 0.4 | 0.4 | 0.4 | 0.4 | 0.4 |
| Hydroxyl group-containing | (G1) | | | | | |
| rosin ester (G) | | | | | | |
| Isocyanate (H) | (H1) | | | | | |

| | | | | | |
|---|---|---|---|---|---|
| NCO/OH (ratio of functional group) | 2.1 | 2.1 | 2.1 | 2.1 | 1.8 |
| Total | 210.9 | 191.1 | 196.2 | 208.3 | 163.9 |

TABLE 3

| Measurement item | | Example 1 | Example 2 | Example 3 | Example 4 | Example 5 |
|---|---|---|---|---|---|---|
| Viscosity (mPas) | | 33500 | 50300 | 53500 | 41750 | 98000 |
| Creep (min) | | 9.6 | 6.8 | 3.3 | 2.3 | 3.1 |
| Evaluation of heat resistance | | ⊚ | ⊚ | ◯ | Δ | ◯ |
| Tack (g/cm²) | 5° C. | 3100 | 2560 | 3461 | 3003 | 2567 |
| | 23° C. | 3650 | 4100 | 4100 | 3900 | 2195 |
| | 35° C. | 4400 | 3000 | 4710 | 3330 | 2582 |
| Evaluation of initial | 5° C. | ⊚ | ◯ | ⊚ | ⊚ | ◯ |
| adhesion strength | 23° C. | ⊚ | ⊚ | ⊚ | ⊚ | ◯ |
| | 35° C. | ⊚ | ⊚ | ⊚ | ⊚ | ◯ |

| | | | | | |
|---|---|---|---|---|---|
| Evaluation of post•curing | ◯ | ◯ | ◯ | ◯ | ◯ |
| adhesion strength (durability) | | | | | |

TABLE 4

| Classification of | Classification of | Classification of | | | | |
|---|---|---|---|---|---|---|
| raw materials 1 | raw materials 2 | raw materials 3 | Example 6 | Example 7 | Example 8 | Example 9 |
| Urethane | Polyol | (A1) | | 32.0 | 36.6 | |
| prepolymer (A) | | (A2) | | | 11.0 | |
| | | (A3) | 60.7 | | | 58.1 |
| | | (A4) | | 11.4 | | |
| | Isocyanate | (A5) | 6.0 | 13.7 | 8.5 | 5.7 |
| Styrene based | Low styrene | (B1-1) | | 42.9 | | |
| block copolymer | content rate (B1) | (B1-2) | | | 24.4 | |
| (B) | | (B1-3) | | | | |
| | | (B1-4) | | | | |
| | | (B1-5) | | | | 29.8 |
| | | (B1-6) | 11.1 | | | |
| | High styrene | (B2-1) | | | | |
| | content rate (B2) | (B2-2) | 22.2 | | | |
| | | (B2-3) | | | 19.5 | |
| | | (B2-4) | | | | 6.4 |

| | | | | | |
|---|---|---|---|---|---|
| Ethylene ethyl acrylate copolymer | (B′ 3) | | | | |
| Urethane modified rosin (C)(C1) | | | | | |
| | (C2) | 36.4 | 78.0 | | |
| | (C3) | 23.0 | | 63.3 | 44.1 |
| | (C4) | | | 12.5 | |
| Hydrocarbon resin (D) | (D1) | 44.4 | | 34.9 | 38.3 |
| | (D2) | | 42.9 | | |
| | (D3) | | | | |
| | (D4) | | | | |
| Plasticizer (E) | (E1) | 22.2 | 42.9 | 35.9 | 31.9 |
| | (E2) | | | | |
| | (E3) | | | | |
| Additive (F) | (F1) | 0.4 | 0.4 | 0.4 | 0.4 |
| Hydroxyl group-containing rosin | (G1) | | | | |
| ester (G) | | | | | |
| Isocyanate (H) | (H1) | | | | |

| | | | | |
|---|---|---|---|---|
| NCO/OH (ratio of functional group) | 2.1 | 2.5 | 1.6 | 2.1 |
| Total | 222.2 | 257.1 | 243.9 | 212.8 |

TABLE 5

| Measurement item | | Example 6 | Example 7 | Example 8 | Example 9 |
|---|---|---|---|---|---|
| Viscosity (mPas) | | 33250 | 56000 | 77000 | 83000 |
| Creep (min) | | 6.3 | 1.2 | 4.8 | 6.5 |
| Evaluation of heat | | ⊚ | Δ | ◯ | ⊚ |
| resistance | | | | | |
| Tack (g/cm²) | 5° C. | 1720 | 7270 | 1920 | 2220 |
| | 23° C. | 2710 | 3969 | 2530 | 2630 |
| | 35° C. | 3380 | 6075 | 2980 | 3140 |
| Evaluation of | 5° C. | Δ | ⊚ | Δ | ◯ |
| initial adhesion | 23° C. | ◯ | ⊚ | ◯ | ◯ |
| strength | 35° C. | ⊚ | ⊚ | ◯ | ⊚ |

| | | | | |
|---|---|---|---|---|
| Evaluation of | ◯ | ◯ | ◯ | ◯ |
| post curing | | | | |
| adhesion strength | | | | |
| (durability) | | | | |

TABLE 6

| Classification | Classification | Classification of | | | | |
|---|---|---|---|---|---|---|
| of raw | of raw | raw | Comparative | Comparative | Comparative | Comparative |
| materials 1 | materials 2 | materials 3 | Example 1 | Example 2 | Example 3 | Example 4 |
| Urethane | Polyol | (A1) | | | | |
| prepolymer | | (A2) | | | 19.2 | |
| (A) | | (A3) | 54.6 | 19.2 | 50.3 | 56.7 |
| | | (A4) | | 7.7 | | |
| | Isocyanate | (A5) | 5.4 | 3.8 | 7.4 | 5.6 |
| Styrene based | Low | (B1-1) | | | | |
| block | styrene | (B1·2) | | | | 37.8 |
| copolymer (B) | content rate | (B1·3) | | | | |
| | (B1) | (B1-4) | | 34.6 | 7.7 | |
| | | (B1-5) | | | | |
| | | (B1·6) | | | | |
| | High | (B2·1) | | 34.6 | 15.4 | |
| | styrene | (B2·2) | | | | |
| | content rate | (B2·3) | | | | |
| | (B2) | (B2-4) | | | | |

| | | | | | |
|---|---|---|---|---|---|
| Ethylene ethyl | (B′ 3) | 40.0 | | | |
| acrylate copolymer | | | | | |
| Urethane modified rosin (C) | (C1) | | | | |
| | (C2) | | | | |
| | (C3) | 41.0 | | | |
| | (C4) | | | | |
| Hydrocarbon resin (D) | (D1) | 32.0 | | | |
| | (D2) | | | 28.2 | |
| | (D3) | | | | |
| | (D4) | | | | |
| Plasticizer (E) | (E1) | 28.0 | | | 25.1 |
| | (E2) | | | | |
| | (E3) | | 28.8 | | |
| Additive (F) | (F1) | 0.4 | 0.4 | 0.4 | 0.4 |
| Hydroxyl group-containing | (G1) | | | | 97.8 |
| rosin ester (G) | | | | | |
| Isocyanate (H) | (H1) | | 67.3 | | 9.6 |

| | | | | |
|---|---|---|---|---|
| NCO/OH (ratio of functional group) | 2.1 | 2.1 | 2.1 | 2.1 |
| Total | 203.1 | 196.2 | 128.2 | 222.9 |

TABLE 7

| | | Compar- | Compar- | Compar- | Compar- |
|---|---|---|---|---|---|
| | | ative | ative | ative | ative |
| | | Example | Example | Example | Example |
| Measurement item | | 1 | 2 | 3 | 4 |
| Viscosity (mPas) | | 10000 | 39000 | Unmixed | 20719 |
| Creep (min) | | 0.5 | 6.0 | — | 3.5 |
| Evaluation of | | X | ⊚ | X | ◯ |
| heat resistance | | | | | |
| Tack (g/cm²) | 5° C. | 2322 | 3750 | — | 2000 |
| | 23° C. | 3012 | 3520 | — | 2800 |
| | 35° C. | 2700 | 5750 | — | 3750 |
| Evaluation of | 5° C. | ◯ | ⊚ | X | ◯ |
| initial adhesion | 23° C. | ⊚ | ⊚ | X | ◯ |
| strength | 35° C. | ◯ | ⊚ | X | ⊚ |

| | | | | |
|---|---|---|---|---|
| Evaluation of | ◯ | X | X | X |
| post curing adhesion | | | | |
| strength (durability) | | | | |

Hereinafter, measurement methods and evaluation methods are described.

### Melt Viscosity

Each of the moisture-curable hot-melt adhesive agents was evaluated for viscosity at 130° C. according to Method B of JAI7-1991. The measurement was performed with a Brookfield viscometer (rotor No. 27).

### Heat Resistance (Creep)

Used as a material for the test was a particle board (10.0 cm×10.0 cm×2 cm) isothermalized in a thermostatic chamber at 25° C. for 12 hours or more. The particle board was coated with each of the hot-melt adhesive agents of the examples and the comparative examples with a roll coater at a coating temperature of 130° C. Thickness of the adhesive agent applied was 70±10 μm.

With the adhesive agent applied, a melamine board (13.0 cm×2.5 cm) was adhered to the particle board. Specifically, the melamine board was placed so as to protrude from the particle board by 2 cm, and both the boards were adhered to each other with a roll pressing machine to give a sample for the creep test.

This sample was immediately fixed to an upper portion of a thermostatic tank at 80° C. The sample was fixed in such a manner that the 2 cm protrusion of the melamine board came downside. The sample was preheated for 1 minute, then a 245 g weight was hung at the tab, or the 2 cm protrusion (melamine board), and a time until the weight dropped was measured to evaluate creep property.

The present test was performed for the purpose of evaluating pre-reaction heat resistance (creep performance), and therefore the series of procedures from the coating to the start of the measurement was performed within 3 minutes.

The creep was evaluated by the time from the start of the measurement until the evaluation piece of the melamine board peeled and dropped. Evaluation criteria are as follows.
⊚: 5.0 minutes or more
◯: 3.0 minutes or more and less than 5.0 minutes
Δ: 1.0 minute or more and less than 3.0 minutes
X: less than 1.0 minute

### Initial Adhesion Strength (Tack)

A 50-μm-thick PET film was coated with each of the hot-melt adhesive agents of the examples and the comparative examples at a thickness of 50 μm, and the coated PET film was placed in a peltier type temperature control unit.

The tack measurement was performed with a tack tester (manufactured by UBM) having a 5 mmφ plunger set therein. The tack measurement was performed at a pressing pressure of 1.5 kg/cm², a pressing time of 1 sec and a speed of plunger vertical movement of 10 mm/sec during the tack measurement.

The measurement was performed under the three temperature conditions for measurement of 5° C., 23° C. and 35° C. The present test was performed for the purpose of evaluating pre-reaction initial adhesion strength, and therefore the series of procedures from the coating to the start of the measurement was performed within 3 minutes.

Evaluation criteria for tack are as follows.
⊚: 3000 g/cm² or more
◯: 2000 g/cm² or more and less than 3000 g/cm²
Δ: 1000 g/cm² or more and less than 2000 g/cm²
X: less than 1000 g/cm²

### Post-Curing Adhesion Strength (Durability)

A material for the test was a particle board (10.0 cm×10.0 cm×2 cm) isothermalized in a thermostatic chamber at 25° C. for 12 hours or more. The particle board was coated with each of the hot-melt adhesive agents of the examples and the comparative examples with a roll coater at a coating temperature of 130° C. Thickness of the adhesive agent applied was 70±10 μm.

With the adhesive agent applied, a melamine board (4.0 cm×10.0 cm) was adhered to the particle board with a roll pressing machine to give a sample. The sample was taken care of at room temperature for 1 week or more and then left to stand still in a thermostatic tank at 60° C. After the sample was left to stand still for 24 hours, it was taken out and visually confirmed for generation of floating and peeling on the melamine board and the particle board.

Evaluation criteria for durability are as follows.
◯: without either floating or peeling
X: with floating or/and peeling

As shown in Tables 3 and 5, the moisture-curable hot-melt adhesive agents of the examples are good in all of heat resistance (creep), initial adhesion strength (tack) and post-curing adhesion strength (durability). Particularly, the moisture-curable hot-melt adhesive agent of Example 1 is high in creep performance to be an index for heat resistance and is good in initial adhesion strength (tack) in a wide range of temperature from 5 to 35° C.

The moisture-curable hot-melt adhesive agents of the comparative examples are, as shown in Table 7, bad in balance among creep, tack and durability and has a cross in any of the evaluation items.

Accordingly, it was demonstrated that the moisture-curable hot-melt adhesive agent is excellent in heat resistance, initial adhesion strength and post-curing adhesion strength by comprising all the components (A), (B) and (C).

### INDUSTRIAL APPLICABILITY

The present invention provides a moisture-curable hot-melt adhesive agent. The moisture-curable hot-melt adhesive agent according to the present invention is effective for producing a layered product for various uses, for example, for exterior and interior materials for building materials, flooring, attachment of a decorative sheet to a substrate, and profile wrapping.

1. A moisture curable hot melt adhesive comprising:
a urethane prepolymer having a terminal isocyanate group (A);
a styrene based block copolymer (B); and
an urethane modified rosin (C), wherein the urethane modified rosin (C) is a reaction product of a rosin derivative having a hydroxyl group and an isocyanate compound.

2. The moisture curable hot melt adhesive according to claim 1, wherein the styrene based block copolymer (B) comprises a styrene based block copolymer having a styrene content of 15% and to 35% by weight (B1) and a styrene based block copolymer having a styrene content of 40% and to 70% by weight (B2).

3. The moisture curable hot melt adhesive according to claim 1, wherein the styrene based block copolymer (B) comprises a styrene based block copolymer having a styrene content of 15% and to 35% by weight and a deblock content rate of 30% to 70% by weight (B1) and a styrene based block copolymer having a styrene content of 40% and to 70% by weight and a deblock content rate of 0% to less than 40% by weight (B2).

4. The moisture curable hot melt adhesive according to claim 1, wherein the styrene based block copolymer (B) comprises a styrene based block copolymer having a styrene content of 15% and to 35% by weight (B1) and a styrene based triblock copolymer having a styrene content of 40% and to 70% by weight (B2).

5. The moisture curable hot melt adhesive according to claim 1, wherein the rosin derivative having a hydroxyl group is an ester of rosin and a polyhydric alcohol.

6. The moisture curable hot melt adhesive according to claim 1, wherein the rosin derivative having a hydroxyl group has a hydroxyl value of 2 to 180 mg KOH/g.

7. The moisture curable hot melt adhesive according to claim 1, comprising 20 to 80 parts by weight of the urethane modified rosin (C) based on 100 parts by weight in total of (A) and (B).

8. The moisture curable hot melt adhesive according to claim 1, wherein the urethane modified rosin (C) is free of isocyanate groups.

9. The moisture curable hot melt adhesive according to claim 1, further comprising a hydrocarbon resin (D).

10. Cured reaction products of the moisture curable hot melt adhesive according to claim 1.

11. A layered product comprising:
a substrate;
an adhesive layer consisting of the moisture curable hot melt adhesive according to claim 1 formed on a surface of the substrate; and
an adherend adhered to a surface of the adhesive layer.
